(19) United States
(12) Patent Application Publication
(10) Pub. No.: US 2008/0254550 A1
(43) Pub. Date: Oct. 16, 2008

(54) DRUG DETECTION KIT AND METHOD

(76) Inventor: Andrew Homer Nathaniel, Alberton (ZA)

Correspondence Address: DARBY & DARBY P.C., P.O. BOX 770, Church Street Station, New York, NY, 10008-0770, US

(21) Appl. No.: 12/026,071

(22) Filed: Feb. 5, 2008

(30) Foreign Application Priority Data
Feb. 5, 2007 (ZA) 2007/01041

(51) Int. Cl. G01N 21/77; G01N 1/02

(52) U.S. Cl. 436/165; 422/61; 422/56

(57) ABSTRACT

This invention relates to a kit and to a method of using the kit for the in situ detection of trace quantities of drugs on any surface. The method involves using a sampling means that is purposefully designed to sample trace elements of a drug to sample an unknown drug, chemically reacting the sampled drug with a buffer or digesting solution to produce a composition which is detectable, by immunological techniques. To test the reacted sample it is placed in a well in a detection tablet that has been impregnated with a detecting chemical and produce a visible indication of the presence of absence of a particular drug.

### FIELD OF THE INVENTION

This invention relates to a kit for detecting the presence of drugs on any surface medium and to a method for detecting said drugs.

### BACKGROUND TO THE INVENTION

The detection of prohibited drugs and, sometimes, other substances is of vital importance to law enforcement agencies worldwide. It is or can be equally important in non-law enforcement applications such as the workplace, in schools, in gymnasiums and even in residential homes for if a potential problem is detected soon enough remedial steps can be instituted often with an appreciable measure of success. Unfortunately the paraphernalia needed to test for drugs, often present in trace amounts, is expensive and bulky. Perhaps the least bulky piece of apparatus is that used at certain airports which makes use of a gas chromatograph or mass spectrometer to detect trace elements of drugs and acetate or similar swabs that are swept over luggage and the like. Gas chromatographs mass spectrometers are however, expensive and specialist skills are required to operate, maintain and calibrate them. Swabs on their own are also used but rely on a subjective colour change that detects and identifies a single class of drug only. These rapid swabs also do not allow for sample to be retained for further confirmatory testing or evidence storage.

In addition, it is often desirable, in law enforcement applications, to test for the presence or absence of a prohibited drug in situ or at the place currently under investigation. This facilitates the apprehending of drug users and pushers and it also lessens the chances of an evidentiary chain being broken. Unfortunately portable means for facilitating the in situ testing for drugs currently involve tedious practical procedures involving many steps in reaching a subjective result that may be inaccurate.

There are certain portable kits that are used to detect drugs but, in the main, these make use of a number of solutions which are aimed at specific drugs or classes of drugs or at specific applications such as the testing of body fluids or urine. Consequently a number of kits need to be used to avoid confusion or the kit must be equipped with a number of different detection solutions into which the drug samples are placed before detection. Furthermore, specific kits are required for testing different surfaces or samples such as liquids, solids, whole plants or tablets or the like and, again, these kits do not allow for the sampled sample to be retained for further confirmatory testing or evidence storage.

In this specification the term “drug” is used loosely and, while it is intended to mean narcotics and other prohibited or banned substances it is also intended to include any chemical substance in which an interest is shown such as, for example, active compounds of pharmaceuticals, steroids and the like. Similarly, the terms “first solution”, “digesting solution” and “buffer solution” are interchangeable.

In summary then, prior art rapid drug detection kits do not provide for the very same sample specimen used to have available for further confirmatory purposes in criminal legal proceedings, or storage, in a separate collection tube. In addition, prior art kits do not provide a means of testing a range of surfaces for a range of substances. Examples of prior art means for detecting drugs are found in U.S. Pat. No. 3,955,926 which is aimed at detecting specific samples for specific narcotic agents unlike the present invention which teats a sample for a range of agents; U.S. Pat. No. 4,320,086 which is used to test only for cocaine and prococaine interferents; U.S. Pat. Nos. 4,752,448, 4,806,487, 4,988,628, 5,057,437 and 5,104,622 which are tests for urine and body fluids; and U.S. Pat. No. 6,514,773 which is aimed at the direct testing an analyte for drugs which is considerably more expensive than the present invention.

### OBJECT OF THE INVENTION

It is an object of this invention to provide a portable kit for the in situ detection of drugs and a method for the in situ detection of drugs.

### SUMMARY OF THE INVENTION

In accordance with this invention there is provided a kit for the in situ detection of drugs said kit comprising a first solution into which an unknown substance is placed and which, in use, acts an at least one drug to form a detectable composition therefrom, and a detecting chemical which reacts, in use, with the detectable composition to produce a visually detectable indication of the presence thereof.

There is also provided for the kit to include a sampling means for collecting the unknown substance prior to its placement into the first solution and for the sampling means to include sampling heads enabling collection of samples from a range of physical forms including collection of powders, crystalline and solid materials from generally flat surfaces, collection of samples from liquids, collection of samples of solid material, preferably tablets and/or plant matter, and collection of samples from resinous matter. Preferably the kit will contain a first sampling means for collecting substances on surfaces with invisible traces of raw drug, from generally planar surfaces; a second sampling means for collecting tablet, crystalline, solid , or plant material; a third sampling means for collecting powder or resin; and a fourth sampling means for collecting liquids.

There is further provided for the first sampling means to be a swab located at one end of an elongate handle; for the second sampling means to be a first solution storage and collection tube; for the third sampling means to be a elongate rod having striations along at least part of its length which collect a sample of a powder or resinous material the rod is dipped into; and for the fourth sampling means to be a combination of buffer tube, collection tube and swab, the sampling means having been developed to avoid, in use, false positive results which accompany any analytical instrument or device where over-sampling occurs.

There is also provided for the first solution to be a buffer or digesting solution which, in use, reacts with a number of raw drugs and, which also, at least partly, convert said drug or drugs in a detectable metabolic, and for the second solution to be an antigenic solution which reacts, in use, with said metabolite or raw drug to provide an indication of the presence thereof.

There is further provides for the first solution to be a composite buffer solution having a buffer which maintains the pH range of the first solution plus any unknown substance placed therein at between 6.8 and 7.3, a microbicide which, in use, inhibits bacterial contamination of the first solution, a polar organic solvent and a surfactant.

There is also provided for the quantity of the first solution to be such that, a sufficient quantity of the first solution and unknown substance to remain, preferably in a sealable container, after testing with the second solution for laboratory testing to be conducted thereby rendering the results of the test suitable for evidentiary purposes.

There is further provided for the second solution to be impregnated into an absorbent material, preferably a detection tablet and for the presence of a detectable drug to be indicated on the tablet by a visible band.

The invention also provides for the detectable drugs to include amphetamines, particularly D-Amphetamine; DL Amphetamine, B-Phenylethylamine, Tryptamine, p-Hydroxyamphetamine, (+) 3,4-ethylenedioxyamphetamine (MDA), L-Amphetamine; cocaine and cocaine derivatives, particularly Benzoylecgonine, Cocaine HCl, Cocaethylene, Ecgonine HCl, Ecgonine methylester;

Marijuana, particularly 11-nor-Δ⁹-THC-9 C00H, Cannabinol, 11-nor-Δ⁸-THC-9 C00H, Δ⁸-THC, Δ⁹-THC; opiates, particularly Morphine, Codeine, Ethylmorphine, Hydromorphine, Hydrocodone, Levorphanol, Oxycodone, Morphine 3-β-D-Glucuronide, Norcodeine, Normorphine, Nalorphine, Oxymorphone, Thebaine, Diacetylmorphine (Heroin), 6-Monoacetylmorphine, Bilirubin; methadone and methadone derivatives particularly Methadone, Doxylamine, Estrone-3-Sulfate; Phencyclidine and tetrahydrozoline; and Methamphetamine, particularly D-Methamphetaniine, Fenfluramine, p-Hydroxymethamphetamine, Methoxyphenamine, 3,4-Methylenedioxymethamphetamine(MDMA), L-Phenylephrine and Procaine.

The invention extends to the components of the above defined kit and, more particularly to the digestive or first solution which is a composite buffer solution having a buffer which maintains the pH range of the first solution plus any unknown substance placed therein at between 6.8 and 7.3, a microbicide which, in use, inhibits bacterial contamination of the first solution, a polar organic solvent and a surfactant, and to the antigenic or second solution.

The invention further extends to a method of detecting trace quantities of drugs using the above-defined kit, details of the components of which are apparent from the description of the embodiments of the invention below.

### BRIEF DESCRIPTION OF THE DRAWINGS

Embodiments of the invention will be described below by way of example only and with reference to the accompanying sketches in which:

FIG. 1 is a part sectional side view of a first embodiment of the first and fourth sampling means according to the invention;

FIG. 2 is a part sectional side view of a first embodiment of all the sampling means according to the invention;

FIG. 3 is sectional side view of an alternate embodiment of a combination first and fourth sampling means according to the invention;

FIG. 4 is one embodiment of a detector tablet for use in the kit according to the invention;

FIG. 5 is a sectional side view of a collection tube for use in the kit of the invention; and

FIGS. 6 to 10 are representations of a operating instructions for a kit for the in situ detection of trace quantities of drugs in the form of a pamphlet, the contents of which are to be incorporated into the body of this specification.

### DETAILED DESCRIPTION OF THE DRAWINGS

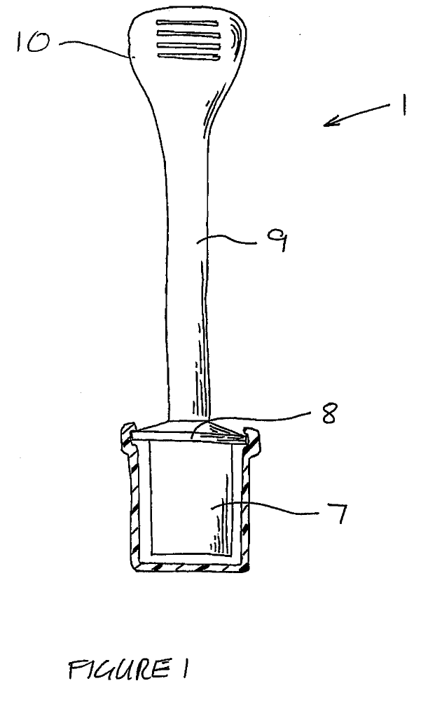

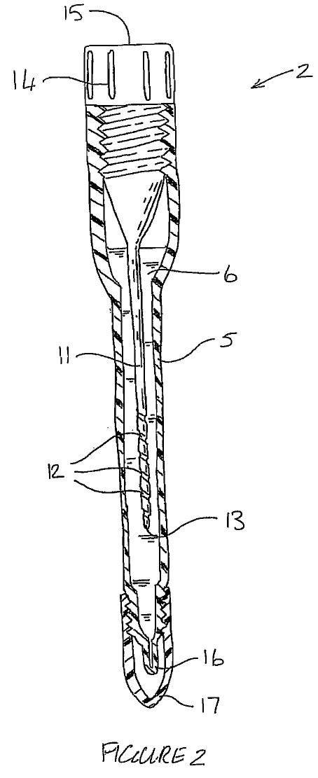

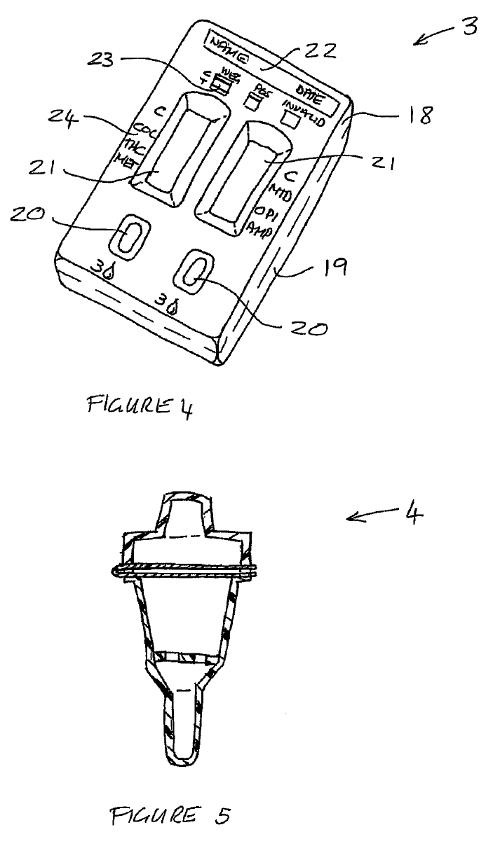

Referring to FIGS. 1, 2, 3, 4 and 5, a kit for the in situ detection of trace quantities of drugs comprises a first sampling means (1) for collection of invisible traces of raw drug on a surface, a second sampling means (2) for collection of tablet, solid or plant material samples, a third sampling means (2) for collection of powder or resin, a fourth sampling means (3) for collection of liquid, a detection tablet (4) and a storage vial (5).

The second sampling means (2) is stored within a vial (5) containing a digesting solution (6) which, in use, at least partly digests a drug in a collected sample to produce a metabolite which, when exposed to a second solution in the detection tablet (4), provides a visual indication of the metabolite and, consequently, of the drug producing the metabolite.

The first sampling means (1) has an absorbent swab (7) in the form of a high adsorbent sponge mounted to one end (8) of an elongate handle (9) having a spatulate portion (10) at its opposite end which can serve to collect powder into a readily samplable pile or as a grip. The swab is covered with a plastics material cap (11) which engages with a radial flange (12) at the end (8) to form a sterile seal which is broken immediately before the swab (7) is used.

The third sampling means (3) is in the form of an elongate rod (11) having a series of striations (12) towards one end (13) and a grip (14) at its opposite end (15). The grip (14) is in the form of a screw threaded closure for the vial (5) into which the rod (11) projects. The vial is charged with the digestive solution (6) and has a narrowing towards its closed end (16). A screw threaded cap (17) is screwed over the closed end (16) of the vial (5).

The detection tablet (4) is generally parallelepipedical in shape and consists of an operatively upper plastics material surface (18) secured to a plastics material base (19) with an absorbent layer sandwiched between. The absorbent layer is impregnated with an antigen solution which provides a visual indication of the presence or absence of a drug. The upper surface (18) of the tablet has two spaced sample wells (20) and two elongate detection boroughs (21), one above each well (20). The face of the upper surface bears indicia which provide for the identity of the sample (22), brief instructions on how to perform the test (23) and abbreviations relating to drugs and a control (24).

The storage vial (5) is manufactured from a synthetic plastics material and has a generally conical body (25) with a cap (26) towards the closed end (27) of the body is located a strainer (28). The vial may be used to store samples of the first solution for later laboratory analysis and result verification and, to this end, it may be sealable with tamper proof strips and it may have surfaces upon which identification on marks can be written.

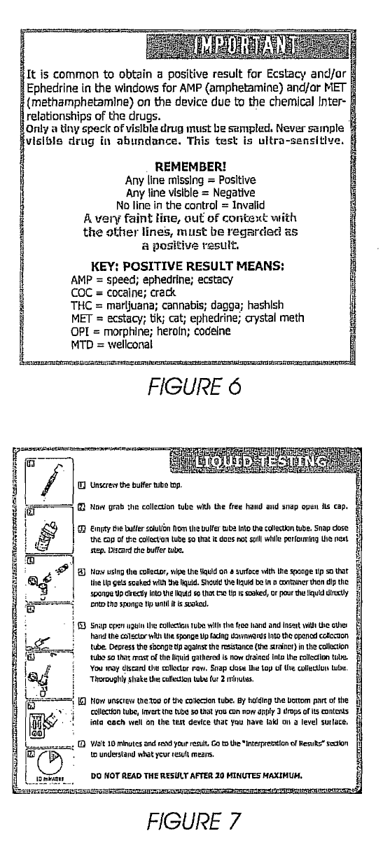

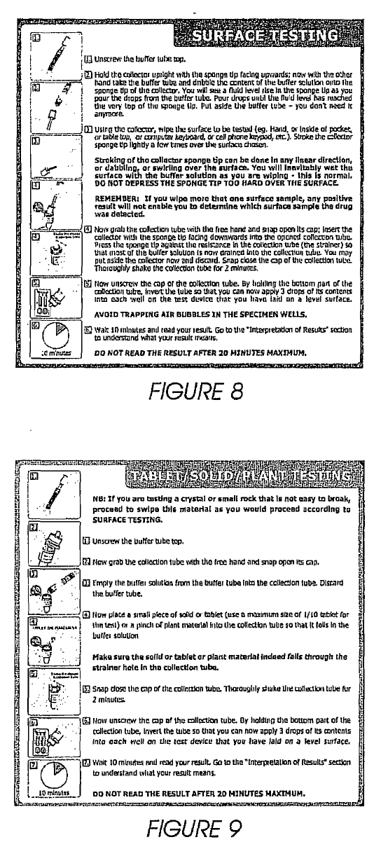

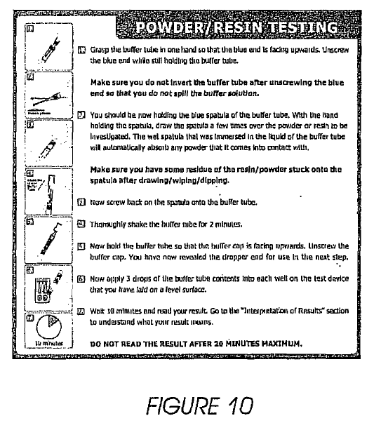

FIGS. 6 to 10 provide an indication of how the kit for the in situ detection of trace quantities of drugs according to the invention is to be used. In summary, the steps are as follows:

When testing a powder, resin or paste-like substance, the following steps are followed: Note that this procedure may also be used for sampling unknown visible powders present in large quantities.
1. Grasp the vial of the third sampling means in one hand and unscrew the end closed with a screw threaded closure while ensuring that the vial is not inverted lest the buffer or digesting solution contained therein spill.
2. Remove the third sampling means from the vial and draw the striated rod end of it a few times over, or dip into, the powder, resin or paste to be investigated ensuring that some residue of the powder, resin or paste is stuck onto the striated rod.
3. Now screw back on the sampling means onto the vial.
4. Thoroughly shake the vial for 2 minutes.
5. Now hold the vial so that the sealed end is facing upwards and break off the tip or, where the vial has a screw threaded closure over the tip, unscrew the closure. In both cases this enables the vial to be used as a dropper.
6. Now apply 3 drops of the vial contents into each well on the tablet that is have laid on a level surface.
7. Wait for 10 minutes and read the result.

If a flat surface or invisible trace quantity of powder is to be sampled, the following steps must be followed: Note that this procedure is to be used for powders that are visible in very minute quantities or for surfaces where suspected trace quantities of drugs are invisible.
1. Grasp the vial of the first sampling means in one hand and unscrew the buffer tube top, or break off its tip end if it has one.
2. Hold the first sampling means upright with the swab tip facing upwards; now with the other hand take the vial and dribble the content of the digesting solution onto the swab tip of the first sampling means. You will see a fluid level rise in the tip as the drops are poured the buffer tube. Pour drops until the buffer fluid content has been emptied, put aside the vial.
3. Using the first sampling means, wipe the surface to be tested (eg. Hand, or inside of pocket, or table top, etc.), or if it is a visible suspicious powder in miniscule quantity dip the means tip onto the powder directly. In either case stroke the means swab tip a few times over the surface or powder chosen with featherlight pressure. Stroking of the tip can be done in any linear direction, or dabbing, or swirling over the surface. Apply featherlight pressure onto the surface.
4. Now grasp the storage vial with a free hand and snap open its cap; insert the means with the sponge tip facing downwards into the opened vial. Press the sponge tip against the resistance of the strainer in the vial. Snap close the cap of the collection tube and thoroughly shake the vial for 2 minutes.
5. Now unscrew the cap of the vial and, by holding the bottom part of the vial, invert it so that 3 drops of its contents can be applied into each well on the tablet that you have laid on a level surface while avoiding trapping air bubbles in the specimen wells.
6. Wait for 10 minutes and read your result.

When testing a tablet or solid or plant material is to be tested, the steps followed are as follows:
1. Grasp the vial of the second sampling means in one hand and break off the tip using the thumb or unscrew the screw threaded closure where it has a screw threaded closure instead of a breakable tip.
2. Now open the storage vial and empty the digestive solution from the second sampling means vial into the storage vial.
3. Now place a small piece of solid or tablet (use a maximum size of 1/10 tablet for the test) or a pinch of plant material into the storage vial so that it falls through the strainer into the digestive solution.
4. Snap close the cap of the storage vial and thoroughly shake for 2 minutes.
5. Now unscrew the cap of the storage vial and invert so that 3 drops of its contents can be applied into each well on the tablet that you have laid on a level surface.
6. Wait 10 minutes and read your result.

To test a liquid, the following steps must be followed: Note that for small droplets of fluid the procedure is as defined below.,
1. Grasp the fourth sampling means vial in one hand and break off the tip using the thumb or, if it has a screw threaded closure, unscrew the closure.
2. Now open the cap of the vial and empty the buffer or digestive solution from the vial tube into the storage vial. Snap close the cap of the storage vial so that it does not spill while performing the next step.
3. Now using the first sampling means, wipe the liquid on a surface with the sponge tip so that the tip gets soaked with the liquid. Should the liquid be in a container then dip the sponge tip directly into the liquid so that the tip is soaked, or pour the liquid directly onto the sponge tip until it is soaked.
4. Snap open again the storage vial with the free hand and insert with the other hand the sampling means with the sponge tip facing downwards into the opened storage vial. Depress the sponge tip against the resistance (the strainer) in the storage vial so that most of the liquid gathered is now drained into the vial. Snap close the top of the vial and thoroughly shake for 2 minutes.
5. Now unscrew the top of the storage vial and invert so that 3 drops of its contents can be supplied into each well on the test device that you have laid on a level surface.
6. Wait 10 minutes and read your results.

To perform the actual test, three drops of the first solution plus the sample are chopped into each sample well (20) of the tablet (3) which is left to stand for ten minutes. After ten minutes a coloured band will show opposite the “C” indication towards the end of the detection troughs. This is a control band and indicates that the kit is functioning correctly. The absence of a “C” band indicates that the entire test was a failure.

A coloured band should show alongside each of the indicia of each trough for a test to be negative for the drugs represented by the indicia. A positive result is indicated by the absence of a band alongside an indicium and the indicium itself provides an indication of the type of drug that tested positive. Bands that are very faint, and require you to look twice to actually see a band must be regarded as a positive result, since this occurs when the cut-off limit of the sensitivity of the test is approached.

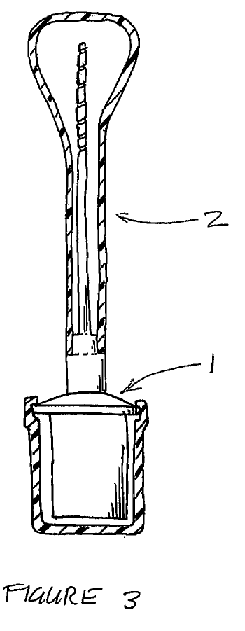

Referring specifically to FIG. 3, an alternative embodiment of a combination first sampling means (1) and second sampling means (2) is shown. Similarly, it should be appreciated that many variations can be made to the above described embodiment of the invention, particularly to the shapes and configurations of the components of the kit, without departing from the scope thereof.

In each case the results should be determined before twenty minutes.

An essential part of the invention is the digestive or first solution which is a composite buffer solution having a buffer which maintains the pH range of the first solution plus any unknown substance placed therein at between 6.8 and 7.3, a microbicide which, in use, inhibits bacterial contamination of the first solution, a polar organic solvent and a surfactant, and to the antigenic or second solution. It is significant in the function of the buffer that the pH range remains stable within the range 6.8-7.3, and hence imperative to prevent bacterial contamination which would alter this pH stability. A number of compounds, many of which are disclosed in the prior art, are capable of fulfilling the function of the first solution. Consequently the actual compounds included in the present invention are not elaborated on in this specification.

1. A kit for the in situ detection of drugs, said kit comprising a first solution into which an unknown substance is placed and which, in use, acts an at least one drug to form a detectable composition therefrom, and a detecting chemical which reacts, in use, with the detectable composition to produce a visually detectable indication of the presence thereof.

2. A kit for the in situ detection of drugs as claimed in claim 1 which includes a sampling means for collecting the unknown substance prior to its placement into the first solution.

3. A kit for the in situ detection of drugs as claimed in claim 2 in which the sampling means to includes sampling heads enabling collection of samples from a range of physical forms including collection of powders, crystalline and solid materials from generally flat surfaces, collection of samples from liquids, collection of samples of solid material, preferably tablets and/or plant matter, collection of samples from resinous matter, and collection of invisible traces of raw drugs on surfaces.

4. A kit for the in situ detection of drugs as claimed in claim 2 in which the kit contains a first sampling means for collecting substances from invisible traces from generally planar surfaces, a second sampling means for collecting tablet, solid, or plant material samples, a third sampling means for collecting powder or resin material samples, and a fourth sampling means for collecting liquids.

5. A kit for the in situ detection of drugs as claimed in claim 4 in which the first and fourth sampling means is a swab located at one end of an elongate handle and the third sampling means is an elongate rod having striations along at least part of its length which collect a sample of a liquid the rod is dipped into.

6. A kit for the in situ detection of drugs as claimed in claim 5 in which the second sampling means includes both a vial for the first solution and a storage vial.

7. A kit for the in situ detection of drugs as claimed in claim 5 in which the first and second sampling means are incorporated into a single unit with the striated rod of the second sampling means serving as the handle of the first sampling means.

8. A kit for the in situ detection of drugs as claimed claim 1 in which the first solution is a buffer or digesting solution which, in use, reacts with a number of drugs and, at least partly, converts said drug or drugs in a detectable metabolite.

9. A kit for the in situ detection of drugs as claimed in claim 8 in which the second solution is an antigenic solution which reacts, in use, with said metabolite to provide an indication of the presence thereof.

10. A kit for the in situ detection of drugs as claimed in claim 8 in which the first solution is a composite buffer solution having a buffer which maintains the pH range of the first solution plus any unknown substance placed therein at between 6.8 and 7.3, a microbicide which, in use, inhibits bacterial contamination of the first solution, a polar organic solvent and a surfactant.

11. A kit for the in situ detection of drugs as claimed in claim 10 in which the quantity of the first solution is such that, a sufficient quantity of the first solution and unknown substance remains after testing with the second solution for laboratory testing to be conducted thereby rendering the results of the test suitable for evidentiary purposes.

12. A kit for the in situ detection of drugs as claimed in claim 11 in which the excess first solution and unknown substance is stored in a sealable container.

13. A kit for the in situ detection of drugs as claimed in claim 1 in which the second solution is impregnated into an absorbent material.

14. A kit for the in situ detection of drugs as claimed in claim 13 in which the absorbent material is in the form of a parallelepipedical tablet and the presence of a detectable drug to be indicated on the tablet by a visible band.

15. A kit for the in situ detection of drugs as claimed claim 1 in which the detectable drugs include amphetamines, cocaine, Marijuana, methamphetamine, opiates, methadone, phencyclidine, and their derivatives.

16. A kit for the in situ detection of drugs as claimed in claim 15 in which the amphetamines are selected from the group consisting of: D-Amphetamine; DL Amphetamine, B-Phenylethylamine, Tryptamine, p-Hydroxyamphetamine, (+) 3,4-ethylenedioxyamphetamine (MDA) and L-Amphetamine.

17. A kit for the in situ detection of drugs as claimed in claim 15 in which the cocaine and cocaine derivatives are selected from the group consisting of: Benzoylecgonine, Cocaine HCl, Cocaethylene, Ecgonine HCl and Ecgonine methylester.

18. A kit for the in situ detection of drugs as claimed in claim 15 in which the marijuana is selected from the group consisting of: 11-nor-Δ⁹-THC-9 C00H, Cannabinol, 11-nor-Δ⁸-THC-9 C00H and Δ⁸-THC, Δ⁹-THC.

19. A kit for the in situ detection of drugs as claimed in claim 15 in which the opiates are selected from the group consisting of: Morphine, Codeine, Ethylmorphine, Hydromorphine, Hydrocodone, Levorphanol, Oxycodone, Morphine 3-β-D-Glucuronide, Norcodeine, Normorphine, Nalorphine, Oxymorphone, Thebaine, Diacetylmorphine (Heroin) and 6-Monoacetylmorphine.

20. A kit for the in situ detection of drugs as claimed in claim 15 in which the methadone and methadone derivatives are selected from the group consisting of: Methadone, Doxylamine, Estrone-3-Sulfate and

21. A kit for the in situ detection of drugs as claimed in claim 15 in which the phencyclidine and phencyclidine derivative are selected from the group consisting of: phencyclidine and tetrahydrozoline.

22. A method for the in situ detection of drugs using a kit as claimed in claim 1 said method comprising the following steps depending on the nature of the surface to be tested:
A) for testing a powder, resin or paste-like substance or sampling unknown visible powders present in large quantities:
i) grasping the vial of the third sampling means in one hand and unscrewing the end closed with a screw threaded closure while ensuring that the vial is not inverted lest the buffer or digesting solution contained therein spill;
ii) removing the third sampling means from the vial and drawing the striated rod end of it a few times over, or dipping it into, the powder, resin or paste to be investigated ensuring that some residue of the powder, resin or paste is stuck onto the striated rod;
iii) screwing back on the sampling means onto the vial;
iv) thoroughly shaking the vial for 2 minutes;
v) holding the vial so that the sealed end is facing upwards and breaking off the tip or, where the vial has a screw threaded closure over the tip, unscrewing the closure thereby enabling the vial to be used as a dropper;
vi) applying 3 drops of the vial contents into each well on the tablet that is laid on a level surface;
vii) waiting for 10 minutes and reading the result from bands that appear on the tablet;
B) for sampling and testing a flat surface or invisible trace quantity of powder is to be sampled such as in cases where powders are visible in very minute quantities or for surfaces where suspected trace quantities of drugs are invisible:
i) grasping the vial of the first sampling means in one hand and unscrewing the buffer tube top, or breaking off its tip end if it has one.
ii) holding the first sampling means upright with the swab tip facing upwards and, with the other hand, taking the vial and dribbling the content of the digesting solution onto the swab tip of the first sampling means until the buffer fluid content has been emptied;
iii) using the first sampling means, wiping the surface to be tested (eg. hand, or inside of pocket, or table top, etc.), or if it is a visible suspicious powder in miniscule quantity dipping the means tip onto the powder directly and, in each case lightly stroking the means swab tip a few times over the surface or powder chosen in any linear direction, or dabbing, or swirling over the surface;
iv) grasping the storage vial with a free hand and snapping open its cap to insert the means with the sponge tip facing downwards into the opened vial;
v) pressing the sponge tip against the resistance of the strainer in the vial before closing the cap of the collection tube and thoroughly shaking the vial for 2 minutes;
vi) unscrewing the cap of the vial and, by holding the bottom part of the vial, inverting it so that 3 drops of its contents can be applied into each well on the tablet that is laid on a level surface while avoiding trapping air bubbles in the specimen wells;
vii) waiting for 10 minutes and from bands that appear on the tablet, reading the results;
C) for testing a tablet or solid or plant material:
i) grasping the vial of the second sampling means in one hand and breaking off the tip or using the thumb or unscrew the screw threaded closure where it has a screw threaded closure instead of a breakable tip;
ii) opening the storage vial and emptying the digestive solution from the second sampling means vial into the storage vial;
iii) placing a small piece of solid or tablet (use a maximum size of 1/10 tablet for the test) or a pinch of plant material into the storage vial so that it falls through a strainer located in the storage vial into the digestive solution;
iv) snapping close the cap of the storage vial and thoroughly shaking for 2 minutes;
v) unscrewing the cap of the storage vial and inverting so that 3 drops of its contents can be applied into each well on the tablet that is laid on a level surface;
vi) waiting for 10 minutes and from bands that appear on the tablet, reading the results;
D) for testing a liquid, the following steps are followed:
i) grasping the fourth sampling means vial in one hand and breaking off the tip using the thumb or, if it has a screw threaded closure, unscrewing the closure.
ii) opening the cap of the vial, emptying the buffer or digestive solution from the vial tube into the storage vial and closing the cap of the storage vial so that it does not spill while performing the next step;
iii) using the first sampling means, wiping the liquid on a surface with the sponge tip so that the tip gets soaked with the liquid or, should the liquid be in a container, dipping the sponge tip directly into the liquid so that the tip is soaked, or pouring the liquid directly onto the sponge tip until it is soaked;
iv) opening the storage vial with a free hand and inserting with the other hand the sampling means with the sponge tip facing downwards into the opened storage vial, depressing the sponge tip against the resistance (the strainer) in the storage vial so that most of the liquid gathered is now drained into the via, closing the top of the vial and thoroughly shaking for 2 minutes;
v) unscrewing the top of the storage vial and inverting it so that 3 drops of its contents can be supplied into each well on the tablet that is laid on a level surface; and
vi) waiting for 10 minutes and from bands that appear on the tablet reading the results.
